(19) United States
(12) Patent Application Publication
(10) Pub. No.: US 2026/0273822 A1
(43) Pub. Date: Sep. 17, 2026

(54) INJECTION MOLDING DEVICE AND MOLD OPENING AND CLOSING DEVICE

(71) Applicant: SEIKO EPSON CORPORATION, Tokyo (JP)

(72) Inventor: Tetsuya TAMURA, MATSUMOTO-SHI (JP)

(73) Assignee: SEIKO EPSON CORPORATION, Tokyo (JP)

(21) Appl. No.: 19/567,365

(22) Filed: Mar. 16, 2026

(30) Foreign Application Priority Data
Mar. 17, 2025 (JP) 2025-042573

(51) Int. Cl. B29C 45/76; B29C 45/66; B29C 45/83

(52) U.S. Cl. CPC B29C 45/76; B29C 45/661; B29C 45/83

(57) ABSTRACT

An injection molding device includes an injection unit, a mold opening and closing unit, and a control section, the mold opening and closing unit includes a toggle fixing section, a fixed mold attachment section, a movable mold attachment section, a crosshead, and a toggle section, the toggle section includes a plurality of pivot sections, a first member, a second member, and a third member, each of the pivot sections includes a pivot shaft, the first member, the second member, and the third member each include an insertion hole into which the pivot shaft is inserted, at least one of the plurality of pivot sections includes a bearing provided between the pivot shaft and the insertion hole and a plurality of protection members that are provided between the pivot shaft and the insertion hole arranged side by side with the bearing in an extending direction of the pivot shaft.

The present application is based on, and claims priority from JP Application Serial Number 2025-042573, filed Mar. 17, 2025, the disclosure of which is hereby incorporated by reference herein in its entirety.

### BACKGROUND

### 1. Technical Field

The present disclosure relates to an injection molding device and a mold opening and closing device.

### 2. Related Art

JP-A-2019-177619 discloses an injection molding machine having a toggle-type mold clamping device. In this injection molding machine, lubricant is supplied by a lubricant supply device to a gap between an inner peripheral surface of a bushing and an outer peripheral surface of a coupling pin, which connects a link and the like included in a toggle mechanism. A supply path through which lubricant flows is provided inside the coupling pin.

In the technology described in JP-A-2019-177619, in order to supply the lubricant between the bearing and the pivot shaft of the toggle section, it is necessary to provide the lubricant supply device and also to form a flow path for the lubricant inside the pivot shaft. Therefore, there is a concern that the structure of the mold opening and closing device becomes complicated.

### SUMMARY

According to a first aspect of the present disclosure, there is provided an injection molding device that uses a mold including a fixed mold and a movable mold to perform injection molding of a molded article. This injection molding device includes an injection unit configured to inject a material of the molded article into the mold; a mold opening and closing unit to which the mold is attached and which opens and closes the mold; and a control section configured to control the injection unit and the mold opening and closing unit, wherein the mold opening and closing unit includes a toggle fixing section, a fixed mold attachment section to which the fixed mold is attached, a movable mold attachment section that is provided between the toggle fixing section and the fixed mold attachment section so as to be movable forward and backward in a mold opening and closing direction and that has the movable mold attached thereto, a crosshead configured to move between the toggle fixing section and the movable mold attachment section, and a toggle section that is connected to the toggle fixing section, the movable mold attachment section, and the crosshead, and that is configured to move the movable mold attachment section along the mold opening and closing direction by movement of the crosshead, the toggle section includes a plurality of pivot sections including a first pivot section, a second pivot section, a third pivot section, a fourth pivot section, and a fifth pivot section, a first member that is coupled to the toggle fixing section via the first pivot section, a second member that is coupled to the first member via the second pivot section and that is coupled to the movable mold attachment section via the third pivot section, and a third member that is coupled to the first member via the fourth pivot section and that is coupled to the crosshead via the fifth pivot section, each of the pivot sections has a pivot shaft, the first member, the second member, and the third member each have an insertion hole through which the pivot shaft is inserted, at least one of the plurality of pivot sections includes a bearing provided between the pivot shaft and the insertion hole and a plurality of protection members that are provided between the pivot shaft and the insertion hole, that are arranged with the bearing in an extending direction of the pivot shaft, and that include a first protection member and a second protection member, the bearing is located between the first protection member and the second protection member, and a first lubricant holding section that holds lubricant is provided at least one of between the bearing and the first protection member and between the bearing and the second protection member.

According to a second aspect of the present disclosure, a mold opening and closing device is provided. The mold opening and closing device includes a toggle fixing section; a fixed mold attachment section to which a fixed mold is attached; a movable mold attachment section that is provided between the toggle fixing section and the fixed mold attachment section so as to be movable forward and backward in a mold opening and closing direction and that has a movable mold attached thereto; a crosshead configured to move between the toggle fixing section and the movable mold attachment section; and a toggle section that is connected to the toggle fixing section, the movable mold attachment section, and the crosshead, and that is configured to move the movable mold attachment section along the mold opening and closing direction by movement of the crosshead, wherein the toggle section includes a plurality of pivot sections including a first pivot section, a second pivot section, a third pivot section, a fourth pivot section, and a fifth pivot section, a first member that is coupled to the toggle fixing section via the first pivot section, a second member that is coupled to the first member via the second pivot section and that is coupled to the movable mold attachment section via the third pivot section, and a third member that is coupled to the first member via the fourth pivot section and that is coupled to the crosshead via the fifth pivot section, each of the pivot sections has a pivot shaft, the first member, the second member, and the third member each have an insertion hole through which the pivot shaft is inserted, at least one of the plurality of pivot sections includes a bearing provided between the pivot shaft and the insertion hole and a plurality of protection members that are provided between the pivot shaft and the insertion hole, that are arranged with the bearing in an extending direction of the pivot shaft, and that include a first protection member and a second protection member, the bearing is located between the first protection member and the second protection member, and a first lubricant holding section that holds lubricant is provided at least one of between the bearing and the first protection member and between the bearing and the second protection member.

### BRIEF DESCRIPTION OF THE DRAWINGS

FIG. 1 is an explanatory view illustrating schematic configuration of an injection molding device.

FIG. 2 is a cross-sectional view illustrating schematic configuration of an injection unit.

FIG. 3 is a perspective view illustrating schematic configuration of a flat screw.

FIG. 4 is a schematic plan view of a barrel.

FIG. 5 is a perspective view of a mold opening and closing unit.

FIG. 6 is an explanatory view illustrating schematic configuration of a mold opening and closing unit.

FIG. 7 is an explanatory view illustrating schematic configuration of a mold opening and closing unit.

FIG. 8 is an enlarged view of a range AR1, which is a portion of FIG. 5.

FIG. 9 is a cross-sectional view of a first pivot section, a first member, and a first pivot shaft fixing section.

FIG. 10 is a perspective view of a first bearing.

FIG. 11 is an enlarged view of a range AR2 in FIG. 9.

FIG. 12 is a cross-sectional view of a fifth pivot section, a third member, and a crosshead.

FIG. 13 is an enlarged view of a range AR2 in FIG. 9 in the second embodiment.

### DESCRIPTION OF EMBODIMENTS

### a. First Embodiment

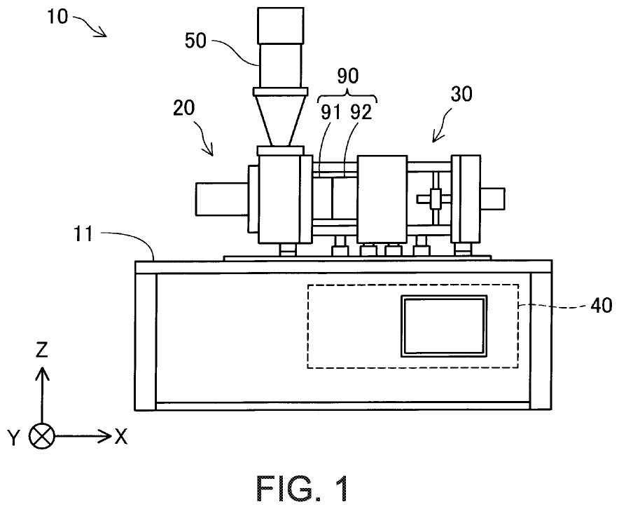

FIG. 1 is an explanatory view illustrating schematic configuration of an injection molding device 10. In FIG. 1, arrows indicating X, Y, and Z directions orthogonal to each other are illustrated. The X direction and the Y direction are directions parallel to a horizontal plane. The Z direction is a direction parallel to the vertical direction. The X, Y, and Z directions in FIG. 1 and the X, Y, and Z directions in other drawings indicate the same directions. When a direction is specified, positive and negative signs are used together with the direction notation, wherein the positive direction, which is the direction indicated by the arrow, is “+” and the negative direction, which is the direction opposite to the direction indicated by the arrow, is “−”.

The injection molding device 10 includes an injection unit 20, a mold opening and closing unit 30, and a control section 40. The injection molding device 10 uses a mold 90 mounted on the mold opening and closing unit 30 to perform injection molding of a molded article. The injection unit 20 and the mold opening and closing unit 30 are fixed on a base 11. The injection molding device 10 is a horizontal injection molding device, and the injection unit 20 and the mold opening and closing unit 30 are arranged in the horizontal direction. The control section 40 is housed in the base 11. In the present disclosure, the mold opening and closing unit 30 is also referred to as a mold opening and closing device.

The control section 40 controls the injection unit 20 and the mold opening and closing unit 30. The control section 40 is configured by a computer including one or a plurality of processors, a memory, and an input/output interface that inputs and outputs signals to and from the outside. The control section 40 exhibits various functions, such as a function of executing a process of molding a molded article, by the processor executing a program or a command read from the main storage device. Note that instead of being configured by a computer, the control section 40 may be realized by a configuration in which a plurality of circuits for realizing at least a part of each function are combined.

A mold 90 made from metal is mounted on the mold opening and closing unit 30. The mold 90 is also referred to as a metal mold. The mold 90 is constituted by a fixed mold 91 and a movable mold 92. The fixed mold 91 is a mold whose position is fixed during the mold clamping operation. The movable mold 92 is a mold that is moved relative to the fixed mold 91 during the mold clamping operation. The movable mold 92 is moved by the mold opening and closing unit 30 in a mold opening and closing direction with respect to the fixed mold 91. The mold opening and closing direction is a direction including a mold clamping direction and a mold opening direction. In the present embodiment, the mold opening and closing direction is the X direction, the mold clamping direction is the −X direction, and the mold opening direction is the +X direction. Note that the mold 90 is not limited to being made of metal, and may be made of resin or ceramic.

A hopper 50 into which material for the molded article is loaded is connected to the injection unit 20. As a material of the molded article, for example, a thermoplastic resin formed in a pellet shape is used. Examples of the thermoplastic resin include acrylonitrile butadiene styrene (ABS), polycarbonate (PC), polyacetal (POM), polypropylene (PP), and polybutylene terephthalate (PBT). The material of the molded article may contain a metal or a ceramic in addition to the thermoplastic resin. The supply of the material to the injection unit 20 is not limited to the hopper 50 and may be performed, for example, via a tube through which the material is pressure-fed.

The injection unit 20 plasticizes at least a part of the material supplied from the hopper 50 to generate a molding material and injects the generated molding material into the mold 90. In the present specification, the term “plasticizing” is a concept including melting and means changing from a solid to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

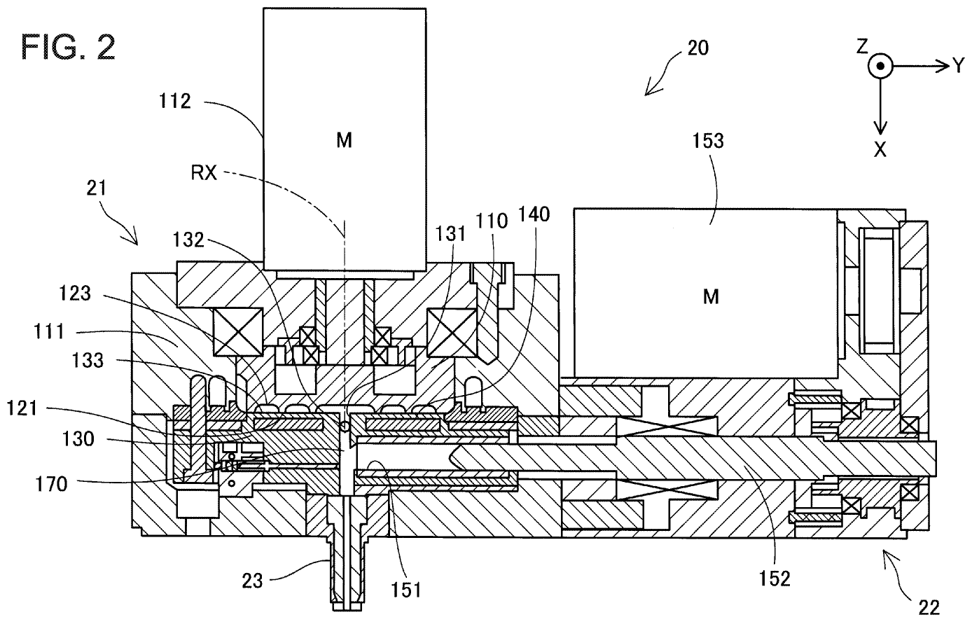

FIG. 2 is a cross-sectional view illustrating schematic configuration of the injection unit 20. The injection unit 20 includes a plasticizing section 21, a suction feeding section 22, and a nozzle 23.

The plasticizing section 21 plasticizes at least a part of the material supplied from the hopper 50 to generate the molding material. The plasticizing section 21 includes a flat screw 110, a barrel 130, and a heater 140. The flat screw 110 is housed in a screw case 111. The flat screw 110 is also referred to as a rotor or simply a screw. The flat screw 110 is driven to rotate about a rotation axis RX in the screw case 111 by a drive motor 112. In the present embodiment, the direction of the rotation axis RX is along the X direction. A communication hole 131 is formed in the center of the barrel 130. The communication hole 131 forms at least a part of the flow path 170 through which the molding material flows. An injection cylinder 151 (to be described later) is connected to the communication hole 131. The communication hole 131 is provided with a check valve 132 at a section upstream of the injection cylinder 151. Rotation of the flat screw 110 by the drive motor 112 and heating by the heater 140 are controlled by the control section 40.

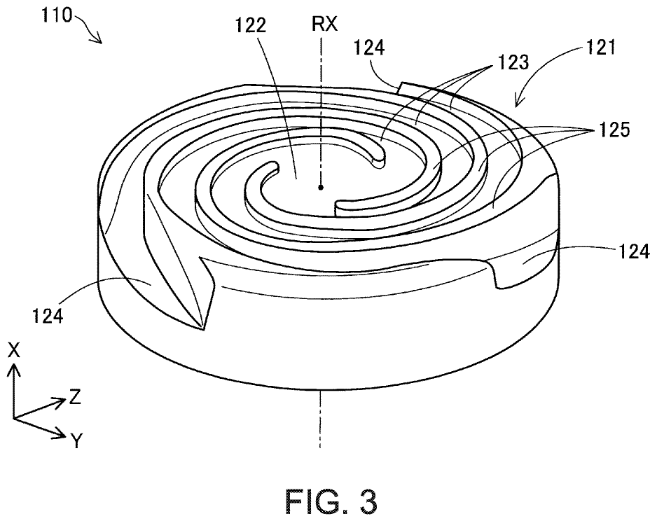

FIG. 3 is a perspective view illustrating schematic configuration of the flat screw 110. The flat screw 110 has a substantially columnar shape in which the height in the direction along the central axis is smaller than the diameter. Vortex-shaped grooves 123 are formed around a central section 122 on a groove forming surface 121 of the flat screw 110 that faces the barrel 130. The grooves 123 communicate with material introduction ports 124 formed on the side surface of the flat screw 110. The material supplied from the hopper 50 is supplied to the grooves 123 through the material introduction ports 124. The grooves 123 are formed by being separated by the ridge sections 125. Although FIG. 3 illustrates an example in which three grooves 123 are formed, the number of grooves 123 may be one or two or more. Note that the grooves 123 are not limited to a vortex shape, and may have a spiral shape or an involute curve shape, or may have a shape extending from the central section 122 toward the outer periphery so as to draw an arc.

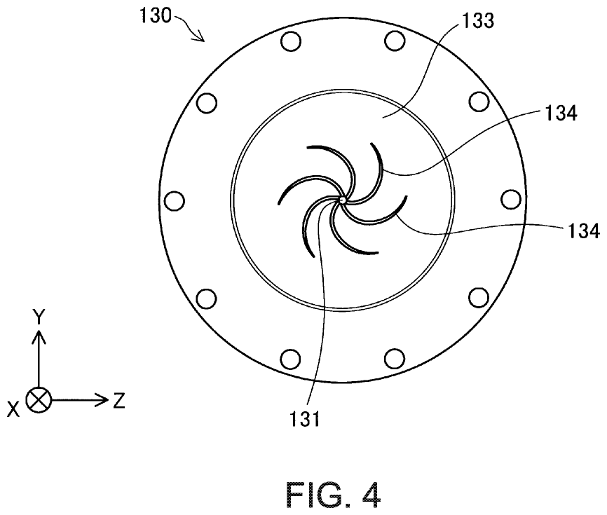

FIG. 4 is a schematic plan view of the barrel 130. The barrel 130 has a facing surface 133 that opposes the groove forming surface 121 of the flat screw 110. A communication hole 131 is formed in the center of the facing surface 133. A plurality of guide grooves 134 are formed in the facing surface 133, are connected to the communication hole 131, and extend in a vortex shape from the communication hole 131 toward the outer periphery. The material supplied to the grooves 123 of the flat screw 110 flows along the grooves 123 and the guide grooves 134 by rotation of the flat screw 110 while being plasticized between the flat screw 110 and the barrel 130 by rotation of the flat screw 110 and heating of the heater 140, and is guided to the central section 122 of the flat screw 110. The material flowing into the central section 122 flows out to the suction feeding section 22 from the communication hole 131 provided at the center of the barrel 130. Note that the barrel 130 may not be provided with the guide grooves 134. The guide grooves 134 may not be connected to the communication hole 131.

As illustrated in FIG. 2, the suction feeding section 22 has an injection cylinder 151, a plunger 152, and a plunger drive section 153. The suction feeding section 22 has a function of injecting the molding material that is in the injection cylinder 151 into a cavity that is defined between the fixed mold 91 and the movable mold 92. The suction feeding section 22 controls the injection amount, the injection speed, and the injection pressure of the molding material from the nozzle 23 under the control of the control section 40. The injection cylinder 151 is a substantially cylindrical member connected to the communication hole 131 of the barrel 130, and includes a plunger 152 inside. The plunger 152 slides inside the injection cylinder 151 and pressure feeds the molding material in the injection cylinder 151 to the nozzle 23, which is provided in the injection unit 20. The plunger 152 is driven by a plunger drive section 153 configured a motor.

A flow path 170 is formed in the nozzle 23. By the plunger 152 pressure feeding the molding material that is in the injection cylinder 151 to the nozzle 23, the molding material is injected from the nozzle 23 into the mold 90. The nozzle 23 may be configured as an open gate type nozzle or a valve gate type nozzle.

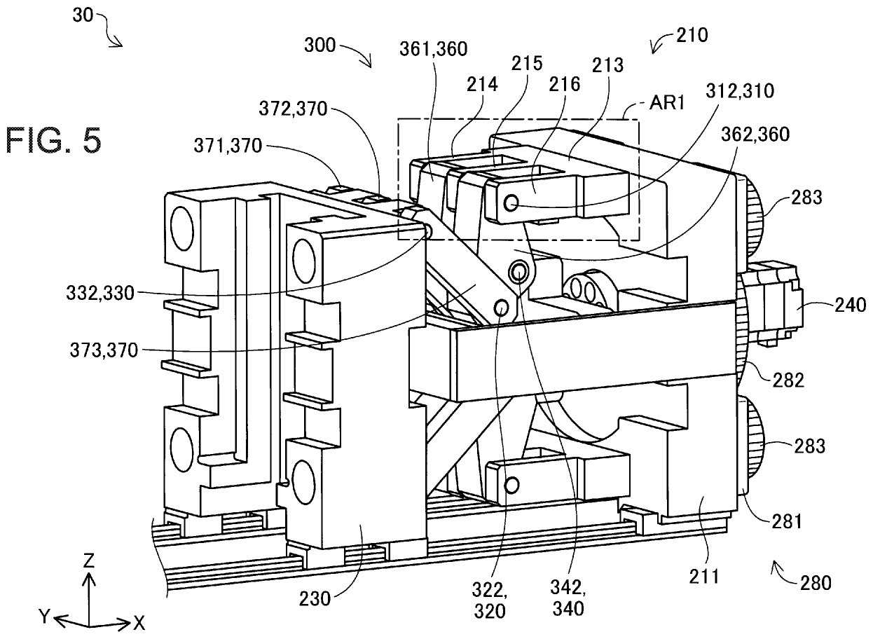

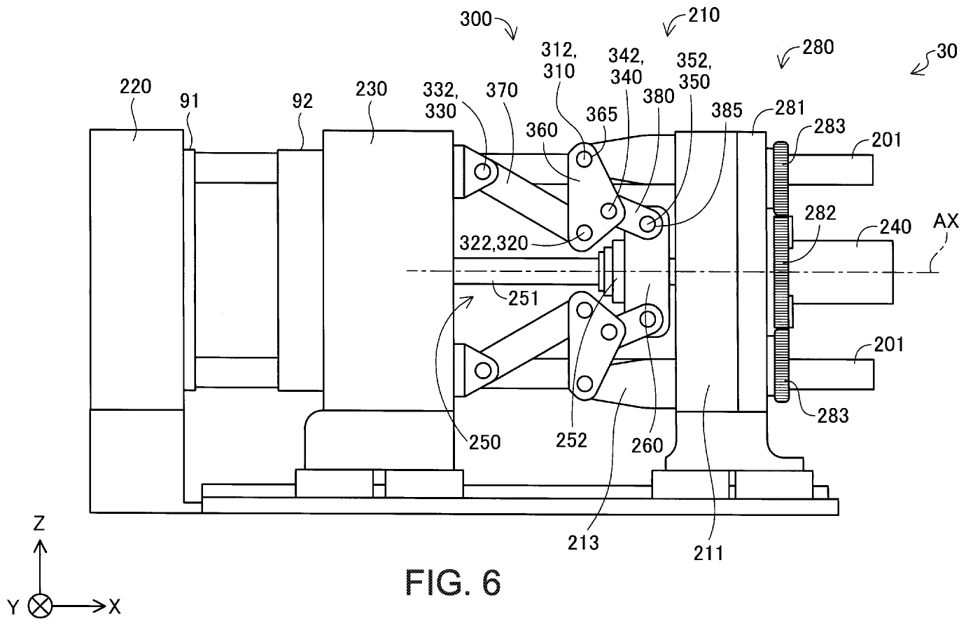

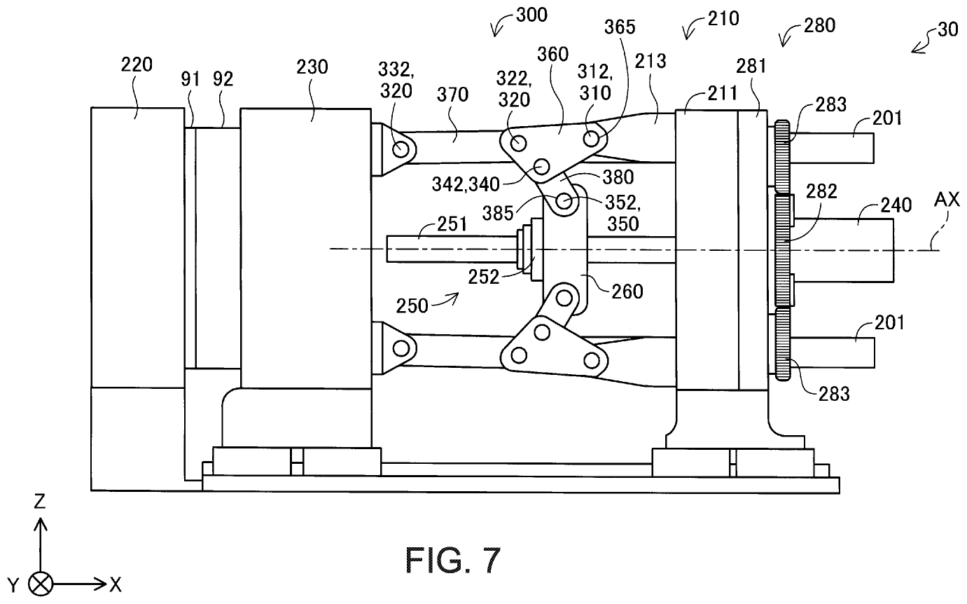

FIG. 5 is a perspective view of the mold opening and closing unit 30. FIGS. 6 and 7 are explanatory views illustrating schematic configuration of the mold opening and closing unit 30. The mold opening and closing unit 30 opens and closes the mold 90 attached to the mold opening and closing unit 30. FIGS. 5 and 6 show a state in which the mold 90 is opened, and FIG. 7 shows a state in which the mold 90 is clamped. The mold opening and closing unit 30 includes a toggle fixing section 210, a fixed mold attachment section 220, a movable mold attachment section 230, a motor 240, a ball screw 250, a crosshead 260, a toggle section 300, and a fixed plate movement section 280.

As illustrated in FIGS. 6 and 7, the fixed mold attachment section 220 is fixed to a −X direction side end section of a tie bar 201, which extends in the X direction. The fixed mold 91 is attached to the fixed mold attachment section 220. The toggle fixing section 210 is provided further to the +X direction side than the fixed mold attachment section 220 so as to be movable along the direction in which the tie bar 201 extends. The movable mold attachment section 230 is provided between the fixed mold attachment section 220 and the toggle fixing section 210 so as to be movable along the direction in which the tie bar 201 extends. That is, the toggle fixing section 210 and the movable mold attachment section 230 are provided so as to be capable of forward and backward in the mold opening and closing direction. The movable mold 92 is attached to the movable mold attachment section 230 so as to face the fixed mold 91. In FIG. 5, the tie bar 201 is omitted.

The toggle fixing section 210 includes a fixed plate 211 and a first pivot shaft fixing section 213. The fixed plate 211 is provided so as to face the movable mold attachment section 230 with the toggle section 300 interposed therebetween. The first pivot shaft fixing section 213 is provided so as to protrude from the fixed plate 211 in the −X direction, which is the mold clamping direction. As illustrated in FIG. 5, the first pivot shaft fixing section 213 includes a first protruding section 214, a second protruding section 215, and a third protruding section 216, which are three protruding sections provided side by side in the Y direction. The first protruding section 214, the second protruding section 215, and the third protruding section 216 are arranged in this order from the +Y direction side toward the −Y direction side. The first pivot shaft fixing section 213 is provided symmetrically with respect to a horizontal plane including an axis AX of a screw shaft 251 (to be described later).

The motor 240 rotates the ball screw 250. The motor 240 is, for example, a servo motor. The motor 240 is controlled by the control section 40.

The ball screw 250 is provided between the toggle fixing section 210 and the movable mold attachment section 230. The ball screw 250 includes a screw shaft 251 and a nut 252. The screw shaft 251 is attached to the toggle fixing section 210 so as to protrude from the fixed plate 211 in the −X direction. The screw shaft 251 is coupled to an output shaft of the motor 240 via a coupling. The screw shaft 251 is rotated about its axis AX by drive of the motor 240. The direction along the axis AX is the X direction. The nut 252 is provided so as to be movable along the screw shaft 251 and moves in the X direction with the rotation of the screw shaft 251. The crosshead 260 is connected to the nut 252.

The crosshead 260 is fixed to the nut 252. Therefore, when the nut 252 moves in the X direction with rotation of the screw shaft 251, the crosshead 260 also moves in the X direction together with the nut 252. That is, the crosshead 260 moves in the X direction between the toggle fixing section 210 and the movable mold attachment section 230 by rotation of the ball screw 250.

The toggle section 300 is connected to the toggle fixing section 210, the movable mold attachment section 230, and the crosshead 260. The toggle section 300 includes a plurality of pivot sections, a first member 360, a second member 370, and a third member 380. The toggle section 300 includes, as pivot sections, a first pivot section 310, a second pivot section 320, a third pivot section 330, a fourth pivot section 340, and a fifth pivot section 350. The respective pivot sections, the first member 360, the second member 370, and the third member 380 are provided symmetrically with respect to a horizontal plane including the axis AX of the screw shaft 251.

Each of the pivot sections includes a pivot shaft, a bearing provided between the pivot shaft and an insertion hole (to be described later), and a protection member 304. The pivot shafts are substantially columnar members extending in a direction orthogonal to the mold opening and closing direction. The pivot shafts are also referred to as toggle pins. In the present embodiment, the pivot shafts extend in the Y direction. The axis of the pivot shafts extends in the Y direction. Hereinafter, the direction in which the pivot shafts extend is also referred to as an extending direction. Hereinafter, the pivot shaft of the first pivot section 310 is also referred to as a first pivot shaft 312, the pivot shaft of the second pivot section 320 is also referred to as a second pivot shaft 322, the pivot shaft of the third pivot section 330 is also referred to as a third pivot shaft 332, the pivot shaft of the fourth pivot section 340 is also referred to as a fourth pivot shaft 342, and the pivot shaft of the fifth pivot section 350 is also referred to as a fifth pivot shaft 352. The bearing and the protection member 304 will be described in detail later.

The first member 360 is connected to the first pivot shaft fixing section 213 of the toggle fixing section 210 via the first pivot section 310. The first member 360 has an insertion hole through which the first pivot shaft 312 is inserted, an insertion hole through which the second pivot shaft 322 is inserted, and an insertion hole through which the fourth pivot shaft 342 is inserted. Hereinafter, the insertion hole provided in the first member 360 and into which the first pivot shaft 312 is inserted is referred to as a first insertion hole 365. The first member 360 is provided so as to be rotatable in the XZ plane, centered on the first pivot shaft 312. The first member 360 is also referred to as a crank. As illustrated in FIG. 5, the first member 360 includes a first crank 361 and a second crank 362, which are two members that have the same shape and that are arranged in the Y direction. The first crank 361 and the second crank 362 are arranged in this order from the +Y direction side toward the −Y direction side. The first crank 361 is positioned between the first protruding section 214 and the second protruding section 215 in the Y-direction. The second crank 362 is positioned between the second protruding section 215 and the third protruding section 216 in the Y-direction.

One end of the second member 370 is connected to the first member 360 via the second pivot section 320 and the other end is connected to the movable mold attachment section 230 via the third pivot section 330. The second member 370 has an insertion hole through which the second pivot shaft 322 is inserted and an insertion hole through which the third pivot shaft 332 is inserted. The second member 370 is provided so as to be rotatable relative to the first member 360 in the XZ plane, centered on the second pivot shaft 322. The second member 370 is provided so as to be rotatable relative to the movable mold attachment section 230 in the XZ plane, centered on the third pivot shaft 332. The second member 370 is also referred to as a connecting rod. As illustrated in FIG. 5, the second member 370 includes a first rod 371, a second rod 372, and a third rod 373, which are three members that have the same shape and that are arranged in the Y direction. The first rod 371, the second rod 372, and the third rod 373 are arranged in this order from the +Y direction side toward the −Y direction side. The first rod 371 is located further to the −Y direction side than the first crank 361. The second rod 372 is positioned between the first crank 361 and the second crank 362 in the Y-direction. The third rod 373 is located further to the +Y direction side than the second crank 362.

The third member 380 has one end connected to the first member 360 via the fourth pivot section 340 and the other end connected to the crosshead 260 via the fifth pivot section 350. The third member 380 has an insertion hole through which the fourth pivot shaft 342 is inserted and an insertion hole through which the fifth pivot shaft 352 is inserted. Hereinafter, the insertion hole provided in the third member 380 and into which the fifth pivot shaft 352 is inserted is referred to as a fifth insertion hole 385. The third member 380 is provided to be rotatable relative to the first member 360 in the XZ plane, centered on the fourth pivot shaft 342. The third member 380 is provided so as to be rotatable relative to the crosshead 260 in the XZ plane, centered on the fifth pivot shaft 352. The third member 380 is also referred to as a link. The third member 380 is positioned between the first crank 361 and the second crank 362 in the Y-direction.

When the crosshead 260 moves in the −X direction, the first member 360, the second member 370, and the third member 380 rotate centered on their respective pivot shafts and, by this, the movable mold attachment section 230 moves in the −X direction. By this, mold clamping of the mold 90 is performed. When the crosshead 260 moves in the +X direction, the first member 360, the second member 370, and the third member 380 rotate centered on their respective pivot shafts and, by this, the movable mold attachment section 230 moves in the +X direction. By this, the mold 90 is opened. In other words, the toggle section 300 moves the movable mold attachment section 230 along the mold opening and closing direction by movement of the crosshead 260. Hereinafter, pivoting of each member of the toggle section 300 centered on each pivot shaft is also referred to as the operation of the toggle section 300.

The fixed plate movement section 280 moves the toggle fixing section 210 along the mold opening and closing direction. The fixed plate movement section 280 includes a base section 281, a first gear 282, a second gear 283, and a fixed plate movement motor (not illustrated). The base section 281 is attached to the +X direction side of the fixed plate 211. The first gear 282 and the second gear 283 are attached to the +X direction side of the base section 281 so that the axes thereof are along the X direction. The first gear 282 is connected to the fixed plate movement motor and rotates about the axis thereof by drive of the fixed plate movement motor. The fixed plate movement motor is controlled by the control section 40. The second gear 283 is meshed with the first gear 282. The second gear 283 has a through hole penetrating through the second gear 283 in the X direction. A screw thread is formed on an inner surface of the through hole. The tie bar 201 is located in the through hole. The screw thread on the inner surface of the through hole is screwed into the screw groove formed on the surface of the tie bar 201. Therefore, when the first gear 282 rotates about its axis, the second gear 283 rotates about its axis, and the fixed plate movement section 280 moves in the X direction along the tie bar 201. By this, the toggle fixing section 210, the motor 240, the ball screw 250, the crosshead 260, the toggle section 300, and the movable mold attachment section 230 integrally move in the X direction together with the fixed plate movement section 280.

The control section 40 drives the motor 240 to control the position of the crosshead 260 and, by this, operate the toggle section 300 and perform mold clamping and mold opening of the fixed mold 91 and the movable mold 92. The control section 40 drives the fixed plate movement motor to control the position of the fixed plate movement section 280 and, by this, move the toggle fixing section 210 to adjust the mold clamping force.

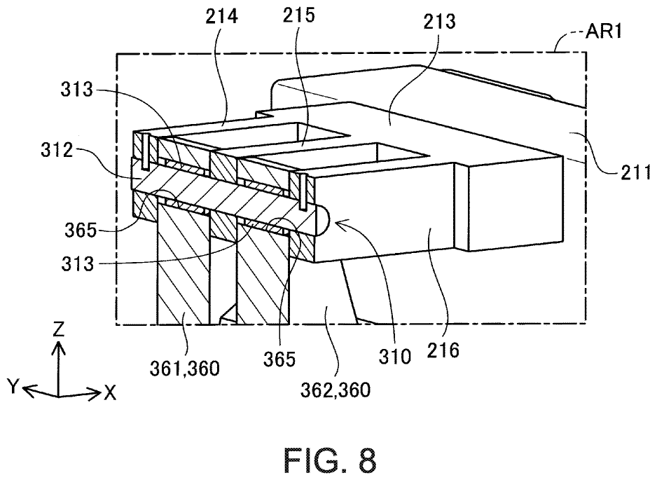

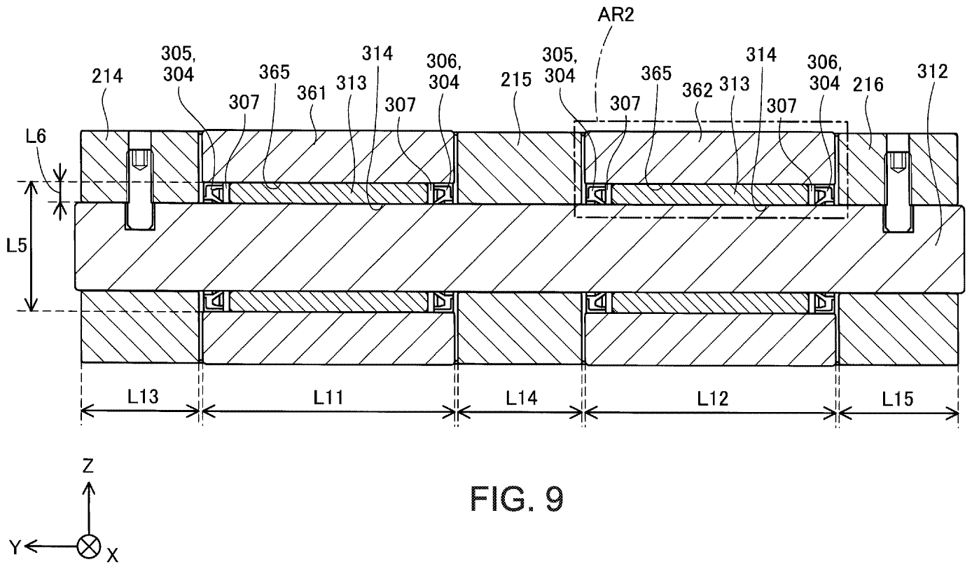

FIG. 8 is an enlarged view of a range AR1, which is a portion of FIG. 5. FIG. 8 illustrates a state in which the first pivot section 310, the first member 360, and the first pivot shaft fixing section 213 are cut along a plane that includes the axis of the first pivot shaft 312 and that is orthogonal to the mold opening and closing direction. FIG. 9 is a cross-sectional view of the first pivot section 310, the first member 360, and the first pivot shaft fixing section 213 in a plane that includes the axis of the first pivot shaft 312 and that is orthogonal to the mold opening and closing direction.

As described above, each of the pivot sections includes a pivot shaft, a bearing, and a protection member 304. Hereinafter, the bearing included in the first pivot section 310 is referred to as a first bearing 313. That is, the first pivot section 310 includes the first pivot shaft 312, the first bearing 313, and the protection member 304.

The first pivot shaft 312 is fixed to the first pivot shaft fixing section 213. Specifically, the first pivot shaft 312 is fixed to the first protruding section 214, the second protruding section 215, and the third protruding section 216. The first pivot shaft 312 penetrates the first protruding section 214, the second protruding section 215, and the third protruding section 216 in the Y direction.

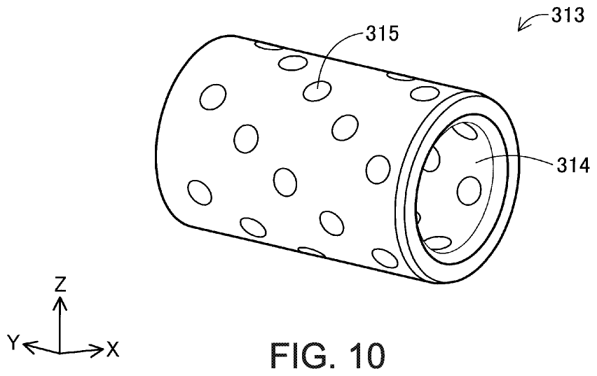

FIG. 10 is a perspective view of the first bearing 313. The first bearing 313 is a cylindrical member having a through hole 314 penetrating the first bearing 313 in the Y direction. In the present embodiment, the first bearing 313 is a bushing. The first bearing 313 is formed of a metal such as a copper alloy, an aluminum alloy, or cast iron. The first bearing 313 is formed with a second lubricant holding section 315 that holds lubricant. The second lubricant holding section 315 is made of graphite, molybdenum, or the like filled with lubricant and is embedded in a plurality of places of the first bearing 313. The lubricant held in the second lubricant holding section 315 is, for example, lubricating oil. As illustrated in FIG. 9, the first pivot shaft 312 is located inside the through hole 314 of the first bearing 313. The first bearing 313 is provided between the first pivot shaft 312 and the first insertion hole 365. In the present embodiment, the first bearing 313 is provided between the first pivot shaft 312 and the first insertion hole 365 that is formed in the first crank 361 and between the first pivot shaft 312 and the first insertion hole 365 that is formed in the second crank 362. Note that the structure of the bearing of pivot sections other than the first pivot section 310 is the same as that of the first bearing 313.

The protection member 304 included in the first pivot section 310 is provided between the first pivot shaft 312 and the first insertion hole 365 and is arranged side by side with the first bearing 313 in the extending direction. The protection member 304 is an oil seal. The protection member 304 includes a first protection member 305 and a second protection member 306. The first protection member 305 and the second protection member 306 are disposed so as to sandwich the first bearing 313 in the extending direction. In other words, the first bearing 313 is located between the first protection member 305 and the second protection member 306. In the example illustrated in FIG. 9, the first protection member 305 is disposed on the +Y direction side of the first bearing 313 and the second protection member 306 is disposed on the −Y direction side of the first bearing 313.

A first lubricant holding section 307 that holds lubricant is provided between the first bearing 313 and the first protection member 305 and between the first bearing 313 and the second protection member 306. In the present embodiment, the first lubricant holding section 307 is provided between the +Y direction side end section of the first bearing 313 and the −Y direction side end section of the first protection member 305, and between the −Y direction side end section of the first bearing 313 and the +Y direction side end section of the second protection member 306. The lubricant held in the first lubricant holding section 307 is preferably a lubricant having a high viscosity. The lubricant held by the first lubricant holding section 307 is, for example, grease. The lubricant held in the first lubricant holding section 307 preferably contains an extreme-pressure additive. Note that the first lubricant holding section 307 may be provided at least one of between the first bearing 313 and the first protection member 305 and between the first bearing 313 and the second protection member 306.

The configuration of the protection member 304 included in pivot sections other than the first pivot section 310 is the same as the protection member 304 included in the first pivot section 310. That is, the protection member 304 is provided between the pivot shaft and the insertion hole and is arranged side by side with the bearing in the extending direction. The bearing is located between the first protection member 305 and the second protection member 306. The first lubricant holding section 307 is provided at least one of between the bearing and the first protection member 305 and between the bearing and the second protection member 306.

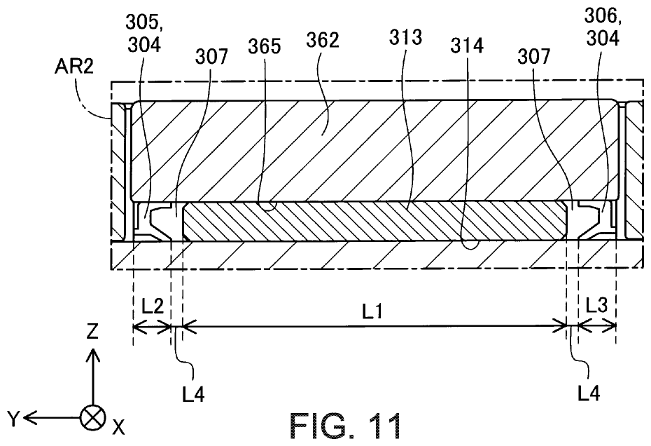

FIG. 11 is an enlarged view of a range AR2 in FIG. 9. As illustrated in FIG. 11, the length L1 of the first bearing 313 in the Y direction, which is the extending direction, is longer than the length L2 of the first protection member 305 and than the length L3 of the second protection member 306 in the Y direction. In the present embodiment, the length L2 of the first protection member 305 in the extending direction and the length L3 of the second protection member 306 in the extending direction are equal to each other. Note that the length L2 in the extending direction of the first protection member 305 and the length L3 in the extending direction of the second protection member 306 may be different from each other. With respect to the extending direction, the length L4 of the first lubricant holding section 307 is shorter than the length L2 of the first protection member 305 and the length L3 of the second protection member 306. The length of the first lubricant holding section 307 in the extending direction means the distance between the first bearing 313 and the first protection member 305 in the extending direction or the distance between the first bearing 313 and the second protection member 306 in the extending direction. In the present embodiment, the distance between the first bearing 313 and the first protection member 305 in the extending direction is equal to the distance between the first bearing 313 and the second protection member 306 in the extending direction. Note that the distance between the first bearing 313 and the first protection member 305 in the extending direction and the distance between the first bearing 313 and the second protection member 306 in the extending direction may be different from each other.

The relationship in length between the protection member 304 and the bearing of pivot sections other than the first pivot section 310 is the same as the relationship in length between the protection member 304 and the bearing of the first pivot section 310. That is, in the extending direction, the length of the bearing is longer than the length of the first protection member 305 and the length of the second protection member 306. With respect to the extending direction, the length of the first lubricant holding section 307 is shorter than the length of the first protection member 305 and the length of the second protection member 306.

As illustrated in FIG. 9, in the extending direction, the length of the portion of the first member 360 in which the first insertion hole 365 is provided is longer than the length of the portion of the first pivot shaft fixing section 213 to which the first pivot shaft 312 is fixed. With respect to the extending direction, the length of the first bearing 313 is longer than the length of the portion of the first pivot shaft fixing section 213 to which the first pivot shaft 312 is fixed. The length in the extending direction of the portion of the first member 360 where the first insertion hole 365 is provided is the sum of the length L11 in the extending direction of the first crank 361 and the length L12 in the extending direction of the second crank 362. In the present embodiment, the length L11 and the length L12 are equal to each other. The length of the portion of the first pivot shaft fixing section 213 to which the first pivot shaft 312 is fixed in the extending direction is the sum of the length L13 of the first protruding section 214 in the extending direction, the length L14 of the second protruding section 215 in the extending direction, and the length L15 of the third protruding section 216 in the extending direction. The length of the first bearing 313 in the extending direction is the sum of the length of the first bearing 313 disposed inside the first insertion hole 365 of the first crank 361 and the length of the first bearing 313 disposed inside the first insertion hole 365 of the second crank 362. In the present embodiment, the length of the first bearing 313 in the extending direction is twice the length L1 illustrated in FIG. 11.

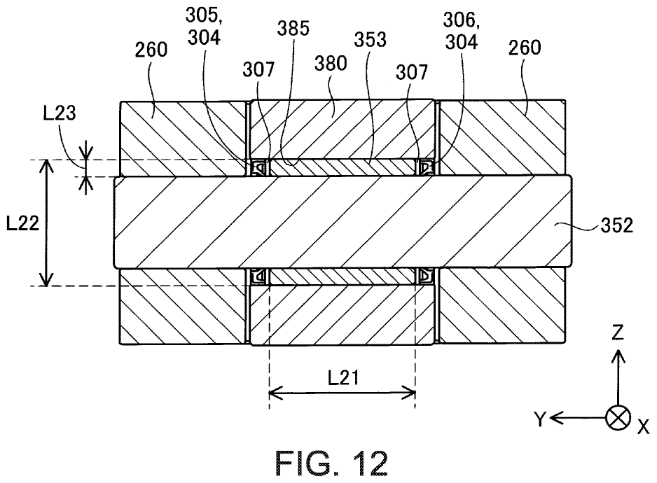

FIG. 12 is a cross-sectional view of the fifth pivot section 350, the third member 380, and the crosshead 260 in a plane that includes the axis of the fifth pivot shaft 352 and that is orthogonal to the mold opening and closing direction. Hereinafter, the bearing included in the fifth pivot section 350 is referred to as a fifth bearing 353. The length L21 of the fifth bearing 353 in the extending direction is shorter than the length L1 of the first bearing 313 in the extending direction. The length L22 of the fifth bearing 353 in the direction intersecting the extending direction is shorter than the length L5 illustrated in FIG. 9 of the first bearing 313 in the direction intersecting the extending direction. In the present embodiment, the direction intersecting the extending direction is a direction orthogonal to the extending direction. That is, the length of the bearing in the direction intersecting the extending direction is the outer diameter of the bearing. The thickness L23 of the fifth bearing 353 in the direction intersecting the extending direction is smaller than the thickness L6 illustrated in FIG. 9 of the first bearing 313 in the direction intersecting the extending direction. In the present embodiment, the thickness of the bearing in the direction intersecting the extending direction is the thickness of the bearing in the direction orthogonal to the extending direction. Note that the direction intersecting the extending direction is not limited to the direction orthogonal to the extending direction. The length of the fifth bearing 353 may be longer than the length of the first bearing 313 in at least one of the extending direction and the direction intersecting the extending direction.

According to the first embodiment described above, the pivot section includes the pivot shaft, the bearing provided between the pivot shaft and the insertion hole, and the plurality of protection members 304 that are provided between the pivot shaft and the insertion hole side by side with the bearing in the extending direction of the pivot shaft and that include the first protection member 305 and the second protection member 306. The bearing is positioned between the first protection member 305 and the second protection member 306 and the first lubricant holding section 307, which holds lubricant, is provided at least one of between the bearing and the first protection member 305 and between the bearing and the second protection member 306. Therefore, the lubricant can be held between the pivot shaft of the toggle section 300 and the bearing with a simple configuration and complication of the structure of the mold opening and closing device can be suppressed. When wear of the bearing progresses by the operation of the toggle section 300, the lubricant held in the first lubricant holding section 307 is supplied to the gap between the pivot shaft and the bearing, and thus it is possible to suppress wear of the components constituting the toggle section 300 and to achieve long life of the toggle section 300.

In the present embodiment, the bearing is formed by the second lubricant holding section 315 that holds lubricant. Therefore, when the bearing is worn by operation of the toggle section 300, the lubricant held in the second lubricant holding section 315 is supplied to the gap between the pivot shaft and the bearing, and thus wear of the components constituting the toggle section 300 can be further suppressed. The maintenance cycle of the toggle section 300 can be lengthened.

With respect to the extending direction, in the present embodiment, the length of the bearing is longer than the length of the first protection member 305 and the length of the second protection member 306. With respect to the extending direction, the length of the first lubricant holding section 307 is longer than the length of the first protection member 305 and the length of the second protection member 306. Therefore, compared to a case where the length of the bearing is shorter than the length of the first protection member 305 and the length of the second protection member 306, the length where the pivot shaft and the bearing contact each other in the extending direction is increased, and thus the possibility of damage to the pivot shaft or the bearing due to the operation of the toggle section 300 can be reduced. It is possible to suppress an increase in the length of the first member 360, the second member 370, or the third member 380 in the extending direction in order to secure the length of the bearing in the extending direction.

With respect to the extending direction, in the present embodiment, the length of the portion of the first member 360 where the first insertion hole 365 is provided is longer than the length of the portion of the first pivot shaft fixing section 213 where the first pivot shaft 312 is fixed, and the length of the first bearing 313 is longer than the length of the portion of the first pivot shaft fixing section 213 where the first pivot shaft 312 is fixed. Therefore, compared to a case where the length of the first bearing 313 is shorter than the length of the portion of the first pivot shaft fixing section 213 to which the first pivot shaft 312 is fixed, the length where the first pivot shaft 312 and the first bearing 313 contact each other in the extending direction is increased, and thus it is possible to reduce the possibility of damage to the first pivot shaft 312 or the first bearing 313 due to the operation of the toggle section 300. It is possible to suppress an increase in the length of the first member 360 in the extending direction in order to secure the length of the first bearing 313 in the extending direction.

In the present embodiment, the length of the fifth bearing 353 is shorter than the length of the first bearing 313 in at least one of the extending direction and the direction intersecting the extending direction. As illustrated in FIG. 7, when the mold 90 is to be clamped, the control section 40 drives the motor 240 to move the crosshead 260 in the mold clamping direction such that the first pivot shaft 312, the second pivot shaft 322, and the third pivot shaft 332 become aligned in a straight line. The first member 360 and the second member 370 apply a mold clamping force to the movable mold attachment section 230 in the mold clamping direction in the mold clamping of the mold 90. Therefore, in the mold clamping operation, a larger force is applied to the first bearing 313 of the first pivot section 310, which couples the first member 360 and the first pivot shaft fixing section 213 together, than to the fifth bearing 353 of the fifth pivot section 350, which couples the third member 380 and the crosshead 260 together. In other words, in the mold clamping operation, the force applied to the fifth bearing 353 is smaller than the force applied to the first bearing 313. Therefore, in the present embodiment, the size of the fifth bearing 353 can be reduced while reducing the possibility of damage to the fifth bearing 353. The manufacturing cost of the toggle section 300 can be reduced.

In the present embodiment, the thickness of the fifth bearing 353 in the direction intersecting the extending direction is smaller than the thickness of the first bearing 313 in the direction intersecting the extending direction. As described above, in the mold clamping operation, the force applied to the fifth bearing 353 is smaller than the force applied to the first bearing 313. Therefore, in the present embodiment, the size of the fifth bearing 353 can be reduced while reducing the possibility of damage to the fifth bearing 353. The manufacturing cost of the toggle section 300 can be reduced.

### B. Second Embodiment

In a second embodiment, a first lubricant holding section 307b is different from that of the first embodiment. The configuration of each part of the injection molding device 10 other than the first lubricant holding section 307b is the same as that of the first embodiment.

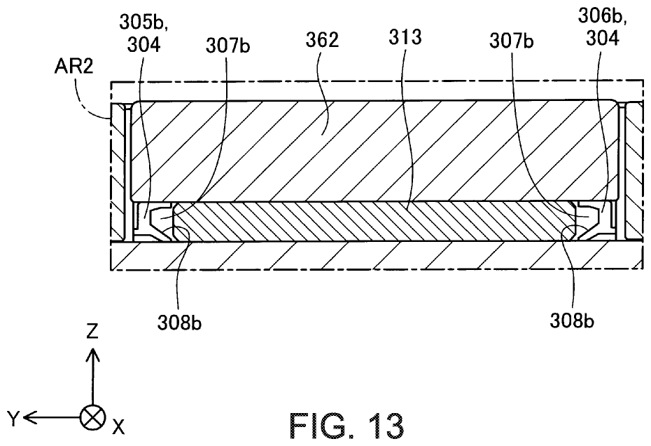

FIG. 13 is an enlarged view of a range AR2 in FIG. 9 in the second embodiment. In the second embodiment, the first lubricant holding section 307b is a recess section 308b formed in the first protection member 305b and the second protection member 306b. The recess section 308b is formed at a position facing the bearing. The recess section 308b of the first protection member 305 is provided on the −Y direction-side surface of the first protection member 305, and the recess section 308b of the second protection member 306 is provided on the +Y direction-side surface of the second protection member 306. Note that the recess section 308b may be formed on at least one of the first protection member 305b or the second protection member 306b. The configuration of the first lubricant holding section 307b included in pivot sections other than the first pivot section 310 is the same as the configuration of the first lubricant holding section 307b included in the first pivot section 310.

According to the second preferred embodiment described above, the first lubricant holding section 307b is the recess section 308b provided in at least one of the first protection member 305b and the second protection member 306b, and the recess section 308b is provided at the position facing the bearings. Therefore, the lubricant can be held between the pivot shaft of the toggle section 300 and the bearing with a simple configuration and complication of the structure of the mold opening and closing device can be suppressed. When wear of the bearings progresses due to operation of the toggle section 300, the lubricant held in the first lubricant holding section 307b is supplied to the gap between the pivot shaft and the bearings and, by this, wear of the components constituting the toggle section 300 can be suppressed and the life of the toggle section 300 can be extended.

### C. Other Embodiments

(C-1) In the above embodiments, the first pivot section 310, the second pivot section 320, the third pivot section 330, the fourth pivot section 340, and the fifth pivot section 350 each include the protection member 304 and the first lubricant holding section 307. In contrast, it is sufficient as long as at least one of the plurality of pivot sections includes the protection member 304 and the first lubricant holding section 307.

(C-2) In the above embodiments, the second lubricant holding section 315 that holds the lubricant is formed in the bearing. In contrast, the second lubricant holding section 315 that holds the lubricant may not be formed in the bearing.

(C-3) In the above embodiments, the length of the bearing is longer than the length of the first protection member 305 and the length of the second protection member 306 in the extending direction. In contrast, the length of the bearing in the extending direction may be equal to or less than the length of the first protection member 305 or equal to or less than the length of the second protection member 306.

(C-4) In the above embodiments, the length of the first lubricant holding section 307 is longer than the length of the first protection member 305 and the length of the second protection member 306 in the extending direction. In contrast, the length of the first lubricant holding section 307 in the extending direction may be equal to or less than the length of the first protection member 305 or equal to or less than the length of the second protection member 306.

(C-5) In the above embodiments, with respect to the extending direction, the length of the portion of the first member 360 in which the first insertion hole 365 is provided is longer than the length of the portion of the first pivot shaft fixing section 213 to which the first pivot shaft 312 is fixed. In contrast, the length in the extending direction of the portion of the first member 360 where the first insertion hole 365 is provided may not be longer than the length of the portion of the first pivot shaft fixing section 213 where the first pivot shaft 312 is fixed.

(C-6) In the above embodiments, the length of the first bearing 313 in the extending direction is longer than the length of the portion of the first pivot shaft fixing section 213 to which the first pivot shaft 312 is fixed. In contrast, the length of the first bearing 313 in the extending direction may not be longer than the length of the portion of the first pivot shaft fixing section 213 to which the first pivot shaft 312 is fixed.

(C-7) In the above embodiments, the length of the fifth bearing 353 is shorter than the length of the first bearing 313 in at least one of the extending direction and the direction intersecting the extending direction. In contrast, the length of the fifth bearing 353 may not be shorter than the length of the first bearing 313 in both the extending direction and the direction intersecting the extending direction.

(C-8) In the above embodiments, the thickness of the fifth bearing 353 in the direction intersecting the extending direction is smaller than the thickness of the first bearing 313 in the direction intersecting the extending direction. In contrast, the thickness of the fifth bearing 353 in the direction intersecting the extending direction may not be smaller than the thickness of the first bearing 313 in the direction intersecting the extending direction.

(C-9) In the above embodiments, the bearing is a bushing. In contrast, the bearing may be a ball bearing, a roller bearing, or the like.

(C-10) In the above embodiments, the bearing is formed with the second lubricant holding section 315 that holds the lubricant. In contrast, the bearing may not include the second lubricant holding section 315, and the bearing itself may be impregnated with the lubricant.

(C-11) In the above embodiments, the first lubricant holding section 307 that holds the lubricant is provided at least one of between the bearing and the first protection member 305 and between the bearing and the second protection member 306. In contrast, the first lubricant holding section 307 may not be provided between the bearing and the first protection member 305 nor between the bearing and the second protection member 306.

(C-12) The above disclosure may be implemented in the aspect of a mold opening and closing device.

### D. Other Aspects

The present disclosure is not limited to the embodiments described above, but can be realized in various forms without departing from the scope of the present disclosure. For example, the present disclosure can be realized by the following aspects. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

(1) According to a first aspect of the present disclosure, an injection molding device that uses a mold configured by a fixed mold and a movable mold to perform injection molding of a molded article is provided. This injection molding device includes an injection unit configured to inject a material of the molded article into the mold; a mold opening and closing unit to which the mold is attached and which opens and closes the mold; and a control section configured to control the injection unit and the mold opening and closing unit, wherein the mold opening and closing unit includes a toggle fixing section, a fixed mold attachment section to which the fixed mold is attached, a movable mold attachment section that is provided between the toggle fixing section and the fixed mold attachment section so as to be movable forward and backward in a mold opening and closing direction and that has the movable mold attached thereto, a crosshead configured to move between the toggle fixing section and the movable mold attachment section, and a toggle section that is connected to the toggle fixing section, the movable mold attachment section, and the crosshead, and that is configured to move the movable mold attachment section along the mold opening and closing direction by movement of the crosshead, the toggle section includes a plurality of pivot sections including a first pivot section, a second pivot section, a third pivot section, a fourth pivot section, and a fifth pivot section, a first member that is coupled to the toggle fixing section via the first pivot section, a second member that is coupled to the first member via the second pivot section and that is coupled to the movable mold attachment section via the third pivot section, and a third member that is coupled to the first member via the fourth pivot section and that is coupled to the crosshead via the fifth pivot section, each of the pivot sections has a pivot shaft, the first member, the second member, and the third member each have an insertion hole through which the pivot shaft is inserted, at least one of the plurality of pivot sections includes a bearing provided between the pivot shaft and the insertion hole and a plurality of protection members that are provided between the pivot shaft and the insertion hole, that are arranged with the bearing in an extending direction of the pivot shaft, and that include a first protection member and a second protection member, the bearing is located between the first protection member and the second protection member, and a first lubricant holding section that holds lubricant is provided at least one of between the bearing and the first protection member and between the bearing and the second protection member.

According to such an aspect, the lubricant can be held between the pivot shaft and the bearing with a simple configuration and complication of the structure of the mold opening and closing device can be suppressed.

(2) The above aspect may be such that the bearing is formed with a second lubricant holding section that holds lubricant.

According to such an aspect, when wear of the bearing progresses by operation of the toggle section, the lubricant held in the second lubricant holding section is supplied to the gap between the pivot shaft and the bearing, and thus wear of the components constituting the toggle section can be further suppressed.

(3) The above aspects may be such that, with respect to the extending direction, a length of the bearing is longer than a length of the first protection member and than a length of the second protection member and a length of the first lubricant holding section is shorter than the length of the first protection member and than the length of the second protection member.

According to such an aspect, since the length where the pivot shaft and the bearing contact each other in the extending direction is longer compared to a case where the length of the bearing is shorter than the length of the first protection member and the length of the second protection member, it is possible to reduce the possibility of the pivot shaft or the bearing being damaged due to the operation of the toggle section.

(4) The above aspects may be such that the first pivot section includes a first pivot shaft and a first bearing, the first member has a first insertion hole through which the first pivot shaft is inserted, the toggle fixing section includes a first pivot shaft fixing section that fixes the first pivot shaft, and with respect to the extending direction, a length of a portion of the first member in which the first insertion hole is provided is longer than a length of a portion of the first pivot shaft fixing section to which the first pivot shaft is fixed and a length of the first bearing is longer than a length of a portion of the first pivot shaft fixing section to which the first pivot shaft is fixed.

According to such an aspect, since the length where the first pivot shaft and the first bearing contact each other in the extending direction is longer compared to a case where the length of the first bearing is shorter than the length of the portion of the first pivot shaft fixing section to which the first pivot shaft is fixed, it is possible to reduce the possibility that the first pivot shaft or the first bearing is damaged due to the operation of the toggle section.

(5) The above aspects may be such that the first pivot section includes a first pivot shaft and a first bearing, the fifth pivot section includes a fifth pivot shaft and a fifth bearing, and a length of the fifth bearing is shorter than a length of the first bearing in at least one of the extending direction and a direction intersecting the extending direction.

In the mold clamping operation, the force applied to the fifth bearing is smaller than the force applied to the first bearing. According to such an aspect, the size of the fifth bearing can be reduced while reducing the possibility of damage to the fifth bearing.

(6) The above aspects may be such that the first pivot section includes a first pivot shaft and a first bearing, the fifth pivot section includes a fifth pivot shaft and a fifth bearing, and a thickness of the fifth bearing in a direction intersecting the extending direction is smaller than a thickness of the first bearing in the direction intersecting the extending direction.

In the mold clamping operation, the force applied to the fifth bearing is smaller than the force applied to the first bearing. According to such an aspect, the size of the fifth bearing can be reduced while reducing the possibility of damage to the fifth bearing.

(7) The above aspects may be such that the first lubricant holding section is a recess section formed in at least one of the first protection member and the second protection member and the recess section is formed at a position facing the bearing.

According to such an aspect, the lubricant can be held between the pivot shaft and the bearing with a simple configuration and complication of the structure of the mold opening and closing device can be suppressed.

(8) According to a second aspect of the present disclosure, a mold opening and closing device is provided. The mold opening and closing device includes a toggle fixing section; a fixed mold attachment section to which a fixed mold is attached; a movable mold attachment section that is provided between the toggle fixing section and the fixed mold attachment section so as to be movable forward and backward in a mold opening and closing direction and that has a movable mold attached thereto; a crosshead configured to move between the toggle fixing section and the movable mold attachment section; and a toggle section that is connected to the toggle fixing section, the movable mold attachment section, and the crosshead, and that is configured to move the movable mold attachment section along the mold opening and closing direction by movement of the crosshead, wherein the toggle section includes a plurality of pivot sections including a first pivot section, a second pivot section, a third pivot section, a fourth pivot section, and a fifth pivot section, a first member that is coupled to the toggle fixing section via the first pivot section, a second member that is coupled to the first member via the second pivot section and that is coupled to the movable mold attachment section via the third pivot section, and a third member that is coupled to the first member via the fourth pivot section and that is coupled to the crosshead via the fifth pivot section, each of the pivot sections has a pivot shaft, the first member, the second member, and the third member each have an insertion hole through which the pivot shaft is inserted, at least one of the plurality of pivot sections includes a bearing provided between the pivot shaft and the insertion hole and a plurality of protection members that are provided between the pivot shaft and the insertion hole, that are arranged with the bearing in an extending direction of the pivot shaft, and that include a first protection member and a second protection member, the bearing is located between the first protection member and the second protection member, and a first lubricant holding section that holds lubricant is provided at least one of between the bearing and the first protection member and between the bearing and the second protection member.

According to such an aspect, the lubricant can be held between the pivot shaft and the bearing with a simple configuration and complication of the structure of the mold opening and closing device can be suppressed.

What is claimed is:

1. An injection molding device that uses a mold configured by a fixed mold and a movable mold to perform injection molding of a molded article, the injection molding device comprising:
an injection unit configured to inject a material of the molded article into the mold;
a mold opening and closing unit to which the mold is attached and which opens and closes the mold; and
a control section configured to control the injection unit and the mold opening and closing unit, wherein
the mold opening and closing unit includes
a toggle fixing section,
a fixed mold attachment section to which the fixed mold is attached,
a movable mold attachment section that is provided between the toggle fixing section and the fixed mold attachment section so as to be movable forward and backward in a mold opening and closing direction and that has the movable mold attached thereto,
a crosshead configured to move between the toggle fixing section and the movable mold attachment section, and
a toggle section that is connected to the toggle fixing section, the movable mold attachment section, and the crosshead, and that is configured to move the movable mold attachment section along the mold opening and closing direction by movement of the crosshead,
the toggle section includes
a plurality of pivot sections including a first pivot section, a second pivot section, a third pivot section, a fourth pivot section, and a fifth pivot section,
a first member that is coupled to the toggle fixing section via the first pivot section,
a second member that is coupled to the first member via the second pivot section and that is coupled to the movable mold attachment section via the third pivot section, and
a third member that is coupled to the first member via the fourth pivot section and that is coupled to the crosshead via the fifth pivot section,
each of the pivot sections has a pivot shaft,
the first member, the second member, and the third member each have an insertion hole through which the pivot shaft is inserted,
at least one of the plurality of pivot sections includes
a bearing provided between the pivot shaft and the insertion hole, and
a plurality of protection members that are provided between the pivot shaft and the insertion hole, that are arranged with the bearing in an extending direction of the pivot shaft, and that include a first protection member and a second protection member,
the bearing is located between the first protection member and the second protection member, and
a first lubricant holding section that holds lubricant is provided at least one of between the bearing and the first protection member and between the bearing and the second protection member.

2. The injection molding device according to claim 1, wherein
the bearing is formed with a second lubricant holding section that holds lubricant.

3. The injection molding device according to claim 1, wherein with respect to the extending direction,
a length of the bearing is longer than a length of the first protection member and than a length of the second protection member and
a length of the first lubricant holding section is shorter than the length of the first protection member and than the length of the second protection member.

4. The injection molding device according to claim 1, wherein
the first pivot section includes a first pivot shaft and a first bearing,
the first member has a first insertion hole through which the first pivot shaft is inserted,
the toggle fixing section includes a first pivot shaft fixing section that fixes the first pivot shaft, and
with respect to the extending direction,
a length of a portion of the first member in which the first insertion hole is provided is longer than a length of a portion of the first pivot shaft fixing section to which the first pivot shaft is fixed and
a length of the first bearing is longer than the length of the portion of the first pivot shaft fixing section to which the first pivot shaft is fixed.

5. The injection molding device according to claim 1, wherein
the first pivot section includes a first pivot shaft and a first bearing,
the fifth pivot section includes a fifth pivot shaft and a fifth bearing, and
a length of the fifth bearing is shorter than a length of the first bearing in at least one of the extending direction and a direction intersecting the extending direction.

6. The injection molding device according to claim 1, wherein
the first pivot section includes a first pivot shaft and a first bearing,
the fifth pivot section includes a fifth pivot shaft and a fifth bearing, and
a thickness of the fifth bearing in a direction intersecting the extending direction is smaller than a thickness of the first bearing in the direction intersecting the extending direction.

7. The injection molding device according to claim 1, wherein
the first lubricant holding section is a recess section formed in at least one of the first protection member and the second protection member and
the recess section is formed at a position facing the bearing.

8. A mold opening and closing device comprising:
a toggle fixing section;
a fixed mold attachment section to which a fixed mold is attached;
a movable mold attachment section that is provided between the toggle fixing section and the fixed mold attachment section so as to be movable forward and backward in a mold opening and closing direction and that has a movable mold attached thereto;
a crosshead configured to move between the toggle fixing section and the movable mold attachment section; and
a toggle section that is connected to the toggle fixing section, the movable mold attachment section, and the crosshead, and that is configured to move the movable mold attachment section along the mold opening and closing direction by movement of the crosshead, wherein
the toggle section includes
a plurality of pivot sections including a first pivot section, a second pivot section, a third pivot section, a fourth pivot section, and a fifth pivot section,
a first member that is coupled to the toggle fixing section via the first pivot section,
a second member that is coupled to the first member via the second pivot section and that is coupled to the movable mold attachment section via the third pivot section, and
a third member that is coupled to the first member via the fourth pivot section and that is coupled to the crosshead via the fifth pivot section,
each of the pivot sections has a pivot shaft,
the first member, the second member, and the third member each have an insertion hole through which the pivot shaft is inserted,
at least one of the plurality of pivot sections includes
a bearing provided between the pivot shaft and the insertion hole, and
a plurality of protection members that are provided between the pivot shaft and the insertion hole, that are arranged with the bearing in an extending direction of the pivot shaft, and that include a first protection member and a second protection member,
the bearing is located between the first protection member and the second protection member, and
a first lubricant holding section that holds lubricant is provided at least one of between the bearing and the first protection member and between the bearing and the second protection member.
